(19) United States
(12) Patent Application Publication
(10) Pub. No.: US 2014/0067569 A1
(43) Pub. Date: Mar. 6, 2014

(54) DEVICE CONNECTION UNIT, COMMODITY SALES PROCESSING SYSTEM AND METHOD

(71) Applicant: TOSHIBA TEC KABUSHIKI KAISHA, Tokyo (JP)

(72) Inventor: Yasuhiro Katabira, Shizuoka-ken (JP)

(73) Assignee: TOSHIBA TEC KABUSHIKI KAISHA, Tokyo (JP)

(21) Appl. No.: 13/965,394

(22) Filed: Aug. 13, 2013

(30) Foreign Application Priority Data
Aug. 31, 2012 (JP) 2012-192549

(51) Int. Cl. G06Q 20/20

(52) U.S. Cl. CPC G06Q 20/202
USPC 705/21

(57) ABSTRACT

In accordance with an embodiment, a device connection unit capable of connecting the peripherals related to a commodity sales processing carries out a data transmission/reception with an information processing terminal if the information stored in the information processing terminal is consistent with that stored in a storage medium accessing the device connection unit.

### CROSS-REFERENCE TO RELATED APPLICATION

This application is based upon and claims the benefit of priority from Japanese Patent Application No. 2012-192549, filed Aug. 31, 2012, the entire contents of which are incorporated herein by reference.

### FIELD

Embodiments described herein relate to a device connection unit, a commodity sales processing system and a commodity sales processing method used in a commodity sales processing supporting a checkout job in a store.

### BACKGROUND

A commodity sales processing apparatus supporting the checkout job in a store, for example, a POS (Point Of Sales) terminal, reads the barcode of the commodity brought by the purchaser to recognize a commodity name and a selling price from the read barcode to carry out a settlement.

As to the number of the POS terminals arranged, it is difficult to set the number as the arrangement of many POS terminals will lead to a high import cost for the store and the arrangement of few POS terminals will lead to a delay in the checkout job during peak hours.

Thus, if an information processing terminal, for example, a personal computer, stored an application program the same as that used in the POS terminals, can be prepared beforehand to deal with the checkout job serving as a POS terminal in peak hours, even if in the case where there are few POS terminals arranged, the job in peak hours may also be dealt with. However, commodity sales processing includes cash settlement and credit card settlement. Therefore, in the case where using a general purpose information processing terminal such as a personal computer serving as a POS terminal, if an optional information processing terminal can be used, there will exist problems in security.

### BRIEF DESCRIPTION OF THE DRAWINGS

FIG. 1 is a block diagram illustrating the overall structure of each embodiment;

FIG. 2 is a block diagram illustrating the control circuits of a device connection unit and an information processing terminal of each embodiment;

FIG. 3 is a flowchart representing the control involved in embodiment 1; and

FIG. 4 is a flowchart representing the control involved in embodiment 2.

### DETAILED DESCRIPTION

In accordance with embodiments described herein, a device connection unit capable of connecting the peripherals related to a commodity sales processing comprises a control unit which carries out the data transmission/reception between an information processing terminal and the device connection unit when the information stored in the information processing terminal is consistent with that stored in a storage medium accessing the device connection unit.

Embodiment 1 is described below with reference to accompanying drawings.

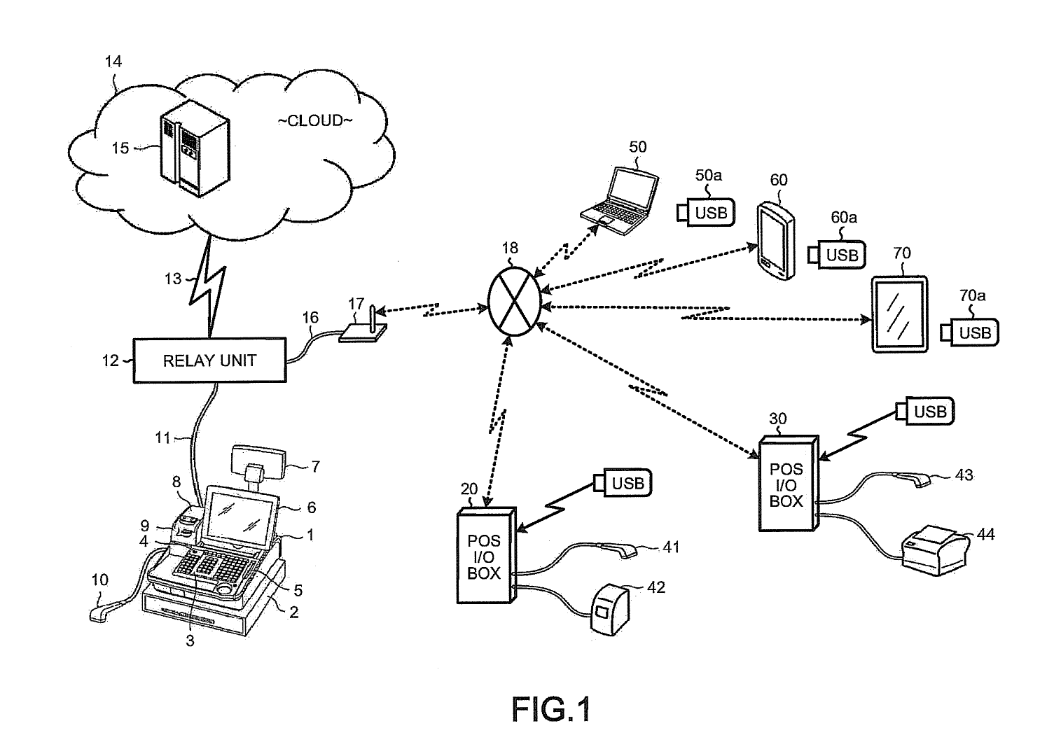

In FIG. 1, 1 denotes a commodity sales processing apparatus, such as a POS (Point Of Sales) terminal, arranged in a register counter in a store, with the main body thereof placed on a drawer 2 for housing cash. In the main body, a keyboard 3, a mode switch 4, a card reader 5 and a display for operator (color liquid crystal display) 6 are arranged on the front side and a customer-oriented display (color liquid crystal display) 7 is arranged on the back side. Further, an electronic journal 8 for storing a journal in an electronic medium and a printer 9 for printing a receipt and a journal are arranged on the main body. Further, a barcode scanner 10 is exported from the main body as a commodity information input unit. The barcode scanner 10 optically reads the barcode on the commodity label affixed to a commodity.

The keyboard 3 includes: a numeric key for input a numeric such as a deposit amount, a subtotal key indicating the total output of the commodities sold and registered in one transaction, a prepayment/cash total key announcing a cash settlement for a payment for one transaction and indicating the closing of the transaction and a clear key indicating the clear of input numeric data.

The mode switch 4 is a switch for selecting ‘Registration’, ‘Inspection’, ‘Fine calculation’, ‘Setting’ and etc, various job modes which is operated using a dedicated key. The mode ‘Registration’ refers to a job mode in which prices of commodities are summated based on the commodity information input by the commodity information unit, a sales registration processing (a commodity registration unit) is conducted for the sales data thereof in a storage section, and a payment for one transaction which announces the ending of a commodity sales registration is made a fine calculation to issue a receipt (registration closing unit). The mode ‘Inspection’ refers to a job mode in which the sales data of each commodity registered in the storage section is totalized and a report is output. The mode ‘Fine calculation’ refers to a job mode in which the sales data in the storage section is cleared after the sales data of each commodity registered in the storage section is totalized and a report is output as in the mode ‘Inspection’. The mode ‘setting’ is a job for setting the data in advance necessary on the implementation of various jobs in the storage section.

The card reader 5 reads the data recorded in a card for a non-cash settlement by inserting into and sliding in the card reader.

The display for operator 6 displays the commodity name and the price of the commodity sold and registered by the commodity registration unit and the total amount, deposit amount and the change amount for a transaction the commodity sales registration of which is announced by the registration closing unit to be ended. The customer-oriented display 7 displays commercial information according to a color picture or a color video, for example, guidance information to a customer such as ‘welcome’, transaction details (commodity name, unit price and commodity quantity) and a transaction result (a total amount, a deposit amount, a change amount), etc.

The POS terminal 1 is connected with the application server 15 of a cloud 14 via a signal cable 11, a relay unit 12 and a communication network 13. The application server 15 stores the application program necessary for the commodity sales processing of the POS terminal 1 and provides the application program to the POS terminal 1. The application program provided is registered in the storage section of the POS terminal 1.

An access point 17 connected with the relay unit 12 via the signal cable 16 carries out wireless communication with various wireless communication devices via a wireless LAN (Local Area Network) 18.

Device connection units (also called as POS I/O BOX or connection integration device) 20, 30, an information processing terminal such as a personal computer 50, an information processing terminal such as a smart phone 60 and an information processing terminal such as a tablet type personal computer 70 are prepared as wireless communication devices capable of wirelessly communicating with the access point 17.

The device connection units 20 and 30 capable of integrally connecting a plurality of the peripherals related to a commodity sales processing are arranged in the store where the POS terminal 1 is placed. The device connection unit 20 is arranged at the same location with the POS terminal 1, such as in the sales area in the first floor. The device connection unit 30 is arranged in the sales area in the second floor. Moreover, as peripherals, the barcode scanner 41 and the printer 42 are connected with the device connection unit 20 while the barcode scanner 43 and the printer 44 are connected with the device connection unit 30.

The personal computer 50, the smart phone 60 and the tablet type personal computer 70 respectively store application program the same as that registered in the POS terminal 1, and are stored in a management office in the store so as to function as substitutes for the POS terminal in peak hours when a delay occurs in the checkout job only because of the POS terminal 1. Further, like that stored in the POS 1, the application programs stored in the personal computer 50, the smart phone 60 and the tablet type personal computer 70 can be downloaded from the application server 15 and then stored.

The personal computer 50, the smart phone 60 and the tablet type personal computer 70 are stored in a store such as in a management office therein together with USB memories 50a, 60a and 70a serving as the storage medium which are possible to connect with the device connection units 20 and 30 to access the device connection units 20 and 30. The USB memories 50a, 60a and 70a are hereinafter referred to as hardware keys 50a, 60a and 70a.

The hardware key 50a stores IP (Internet Protocol) address which is a unique information to the personal computer 50, an identification information such as words, images and colors is attached to the IP address for recognizing that the IP address is belonging to the personal computer 50 at a glance. The hardware key 60a stores IP address which is a unique information to the smart phone 60, an identification information such as words, images and colors is attached to the IP address for recognizing that the IP address is belonging to the smart phone 60 at a glance. The hardware key 70a stores IP address which is a unique information to the tablet type personal computer 70, an identification information such as words, images and colors is attached to the IP address for recognizing that the IP address is belonging to the tablet type personal computer 70 at a glance.

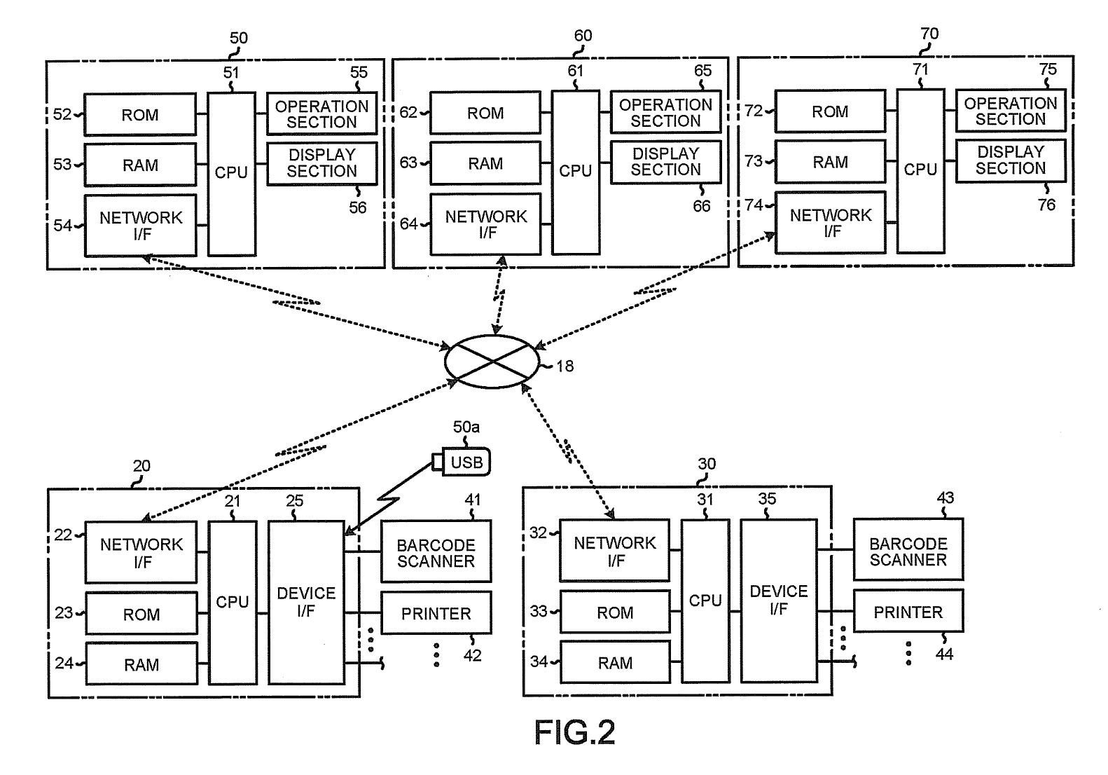

As shown in FIG. 2, the device connection unit 20 comprises a CPU 21 serving as a control section and a network interface 22, a ROM 23, a RAM 24 and a device interface 25 which are connected with the CPU 21. The network interface 22 carries out a data transmission/reception with a wireless LAN 18. The ROM 23 stores a control program. The RAM 24 stores various data. The device interface 25 comprises a plurality of USB ports for connecting the peripherals related to a commodity sales processing and the hardware keys 50a, 60a and 70a.

The device connection unit 30 comprises a CPU 31 serving as a control section and a network interface 32, a ROM 33, a RAM 34 and a device interface 35 which are connected with the CPU 31. The network interface 32 carries out a data transmission/reception with the wireless LAN 18. The ROM 33 stores a control program. The RAM 34 stores various data. The device interface 35 comprises a plurality of USB ports for connecting the peripherals related to a commodity sales processing and the hardware keys 50a, 60a and 70a.

The personal computer 50 comprises a CPU 51 serving as a control section and a ROM 52, a RAM 53, a network interface 54, an operation section 55 and a display section 56 which are connected with the CPU 51. The ROM 52 stores the control program of the personal computer 50, an application program for a commodity sales processing which is the same as that registered in the POS terminal 1 and the specified IP address of the personal computer 50. The RAM 53 stores various data. The network interface 54 carries out a data transmission/reception with the wireless LAN 18. The operation section 55 includes a keyboard for data input. The display section 56 includes a liquid crystal display for displaying words or images.

The smart phone 60 comprises a CPU 61 serving as a control section and a ROM 62, a RAM 63, a network interface 64, an operation section 65 and a display section 66 which are connected with the CPU 61. The ROM 62 stores the control program of the smart phone 60, an application program for a commodity sales processing which is the same as that registered in the POS terminal 1 and the specified IP address of the smart phone 60. The RAM 63 stores various data. The network interface 64 carries out a data transmission/reception with the wireless LAN 18. The operation section 65 includes a touch panel for data input. The display section 56 includes a liquid crystal display for displaying words or images.

The tablet type personal computer 70 comprises a CPU 71 serving as a control section and a ROM 72, a RAM 73, a network interface 74, an operation section 75 and a display section 76 which are connected with the CPU 71. The ROM 72 stores the control program of the tablet type personal computer 70, an application program for a commodity sales processing which is the same as that registered in the POS terminal 1 and the specified IP address of the tablet type personal computer 70. The RAM 73 stores various data. The network interface 74 carries out a data transmission/reception with the wireless LAN 18. The operation section 75 includes a touch panel for data input. The display section 76 includes a liquid crystal display for displaying words or images.

In the commodity sales processing system with a structure described above, as a main function based on the control program in the ROM 23, the CPU 21 of the device connection unit 20 comprises the following unit (1):

(1) a control section which executes a data transmission/reception between the personal computer 50, the smart phone 60 and the tablet type personal computer 70 and the device connection unit 20 if the IP address respectively stored in the personal computer 50, the smart phone 60 and the tablet type personal computer 70 is consistent with that respectively stored in the hardware keys 50a, 60a and 70a connected with the device connection unit 20.

As a main function based on the control program in the ROM 33, the CPU 31 of the device connection unit 30 comprises the following unit (11):

(11) a control section which executes a data transmission/reception between the personal computer 50, the smart phone 60 and the tablet type personal computer 70 and the device connection unit 30 if the IP address respectively stored in the personal computer 50, the smart phone 60 and the tablet type personal computer 70 is consistent with that respectively stored in the hardware keys 50a, 60a and 70a connected with the device connection unit 30.

On the other hand, as main functions based on each control program in the ROM 52, 62 and 72, the personal computer 50, the smart phone 60 and the tablet type personal computer 70 comprise the following units (21) and (22):

(21) a first control section which executes the commodity sales processing according to each application program in the ROM 52, the ROM 62 and the ROM 72 with the peripherals (the barcode scanner 41 and the printer 42) connected with the device connection unit 20 based on the data transmission/reception with the device connection unit 20.

(22) a second control section which executes the commodity sales processing according to each application program in the ROM 52, the ROM 62 and the ROM 72 with the peripherals (the barcode scanner 43 and the printer 44) connected with the device connection unit 30 based on the data transmission/reception with the device connection unit 30.

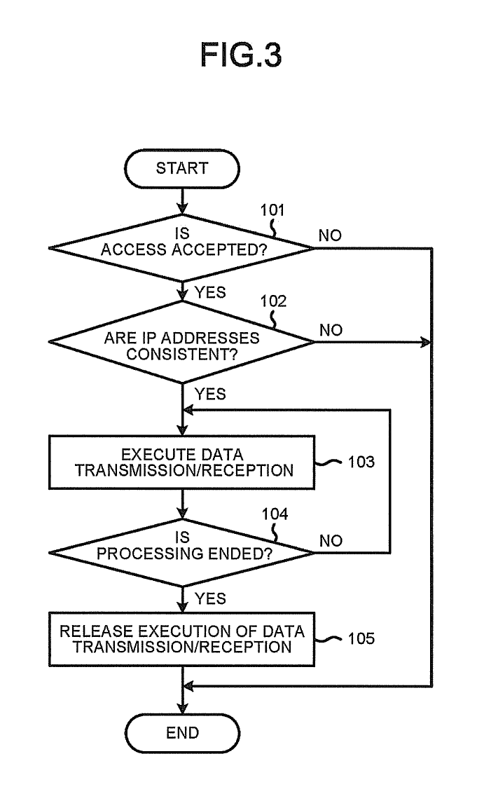

Next, the control executed by the CPU 21 of the device connection unit 20 is described below with reference to the flowchart in FIG. 3. The control executed by the CPU 31 of the device connection unit 30, as identical to that executed by the CPU 21 of the device connection unit 20, is omitted here.

The shop clerk in the store desiring to use the personal computer 50 as a POS terminal takes out the personal computer 50 and the hardware key 50a affiliated to the personal computer 50 from the management office and connects the hardware key 50a with the device interface 25 of the device connection unit 20. Then, the shop clerk starts the personal computer 50 to access the device connection unit 20.

Upon accepting the access from the personal computer 50 (YES in ACT 101), the CPU 21 of the device connection unit 20 compares the IP address sent from the personal computer 50 with the access with that in the hardware key 50a connected with the device interface 25 (ACT 102).

If the result of the comparison is that the two IP addresses are consistent (YES in ACT 102), the CPU 21 of the device connection unit 20 executes a data transmission/reception between the personal computer 50 and the barcode scanner 43 and the printer 44 connected with the device connection unit 20 (ACT 103)

The personal computer 50 executes the commodity sales processing according to the application program in the ROM 52 with the peripherals (the barcode scanner 41 and the printer 42) connected with the device connection unit 20 based on the execution of a data transmission/reception with the device connection unit 20.

Then, the CPU 21 of the device connection unit 20 releases the execution of a data transmission/reception (ACT 105) with the ending of the commodity sales processing according to the personal computer 50 (YES in ACT 104).

As stated above, by executing a data transmission/reception between the personal computer 50 and the device connection unit 20 when the IP address of the personal computer 50 is consistent with that in the hardware key 50a connected with the device connection unit 20, a commodity sales processing becomes possible using the personal computer 50, the barcode scanner 41 and the printer 42.

A commodity sales processing cannot be executed using the smart phone 60, the barcode scanner 41 and the printer 42 as long as the hardware key 60a affiliated to the smart phone 60 is not connected to the device connection unit 20 even if another shop clerk takes out the smart phone 60 to access the device connection unit 20.

A commodity sales processing cannot be executed using the tablet type personal computer 70, the barcode scanner 41 and the printer 42 as long as the hardware key 70a affiliated to the tablet type personal computer 70 is not connected to the device connection unit 20 even if another shop clerk takes out the tablet type personal computer 70 to access the device connection unit 20.

The execution of a commodity sales processing is impossible because of the absence of a hardware key, no matter a third party prepares what information processing terminal and desires to execute a commodity sales processing.

Thus, a commodity sales processing including a cash settlement or a credit card settlement can be executed by using not only a dedicated POS terminal 1 but also a general purpose information processing terminal while a high security is ensured. The use of a general purpose information processing terminal prevents the delay of the checkout job in peak hours, etc.

The shop clerk using the personal computer 50 wants to carry out a commodity sales processing when moved to the sales area in the second floor, provided by connecting the hardware key 50a removed from the device interface 25 of the device connection unit 20 to the device interface 35 of the device connection unit 30 placed in the second floor.

In this case, a commodity sales processing becomes possible in the second floor using the personal computer 50, the barcode scanner 43 and the printer 44 as the IP address sent from the personal computer 50 is consistent with that in the hardware key 50a connected with the device interface 35. That is, the personal computer 50 can be shared to control the peripherals connected with a plurality of device connection units 20 and 30.

Further, the IP address stored in the hardware keys 50a, 60a and 70a can be rewritten along with those of the personal computer 50, the smart phone 60 and the tablet type personal computer 70 through a given operation in the personal computer 50, the smart phone 60 and the tablet type personal computer 70. In this way, the IP address can be changed rapidly to improve security.

Embodiment 2 is described below.

In embodiment 2, the ROM 23 of the device connection unit 20 and the ROM 33 of the device connection unit 30 store the identification information, that is, the so-called ID code, of a person allowed to use the commodity sales processing system.

As a main function based on the program in the ROM 23, the CPU 21 of the device connection unit 20 has the following unit (31):

(31) a control section which executes a data transmission/reception between the personal computer 50, the smart phone 60 and the tablet type personal computer 70 and the device connection unit 20 if the IP address serving as information respectively stored in the personal computer 50, the smart phone 60 and the tablet type personal computer 70 is consistent with the IP address serving as information respectively stored in the hardware keys 50a, 60a and 70a connected with the device connection unit 20 and the ID code sent from the personal computer 50, the smart phone 60 and the tablet type personal computer 70 is consistent with any one of ID codes in the ROM 23.

As a main function based on the program in the ROM 33, the CPU 31 of the device connection unit 30 has the following unit (41):

(41) a control section which executes a data transmission/reception between the personal computer 50, the smart phone 60 and the tablet type personal computer 70 and the device connection unit 30 if the IP address serving as information respectively stored in the personal computer 50, the smart phone 60 and the tablet type personal computer 70 are consistent with the IP address serving as information respectively stored in the hardware keys 50a, 60a and 70a connected with the device connection unit 30 and the ID code sent from the personal computer 50, the smart phone 60 and the tablet type personal computer 70 is consistent with any one of ID codes in the ROM 33.

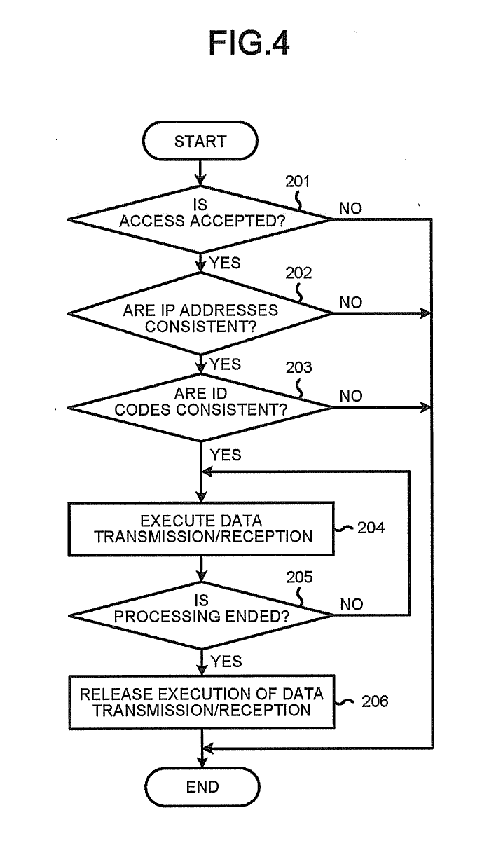

The control executed by the CPU 21 of the device connection unit 20 is described below with reference to the flowchart in FIG. 4. The control executed by the CPU 31 of the device connection unit 30, as identical to that executed by the CPU 21 of the device connection unit 20, is omitted here.

The shop clerk in the store desiring to use the personal computer 50 as a POS terminal takes out the personal computer 50 and the hardware key 50a affiliated to the personal computer 50 from the management office and connects the hardware key 50a to the device interface 25 of the device connection unit 20. Then, the shop clerk starts the personal computer 50 and access the device connection unit 20 after inputting an ID code serving as the specified identification information of a clerk into the personal computer 50.

When accepting the access from the personal computer 50 (YES in ACT 201), the CPU 21 of the device connection unit 20 compares the IP address sent from the personal computer 50 with the access with that in the hardware key 50a connected with the device interface 25 (ACT 202). In addition, the ID code sent from the personal computer 50 with the access is compared with each ID code in the ROM 23 (ACT 203).

The CPU 21 of the device connection unit 20 allows a data transmission/reception between the personal computer 50 and the device connection unit 20 (ACT 204) if the result of comparison of the IP addresses is consistent (Yes in ACT 202) and the result of comparison of the ID codes is consistent (Yes in ACT 203).

The personal computer 50 executes the commodity sales processing according to the application program in the ROM 52 with the peripherals (the barcode scanner 41 and the printer 42) connected with the device connection unit 20 based on the data transmission/reception with the device connection unit 20.

Then, the CPU 21 of the device connection unit 20 releases the execution of a data transmission/reception (ACT 206) with the ending of the commodity sales processing according to the personal computer 50 (Yes in ACT 205).

In this way, by executing a data transmission/reception between the personal computer 50 and the device connection unit 20 when the IP address of the personal computer 50 is consistent with that in the hardware key 50a connected with the device connection unit 20 and the ID code input by the user of the personal computer 50 is consistent with that registered in the device connection unit 20 beforehand, a commodity sales processing using the personal computer 50, the barcode scanner 41 and the printer 42 becomes possible if a clerk is one who is allowed to use the system.

The execution of a commodity sales processing cannot be executed in the case that a clerk is not the person allowed to use the commodity sales processing system even if the hardware key 50a is connected to the device connection unit 20. Apparently, the execution of a commodity sales processing is also impossible in the case where no matter a third party prepares what an information processing terminal and desires to execute the commodity sales processing.

Thus, a commodity sales processing including a cash settlement or a credit card settlement can be executed by using not only a dedicated POS terminal 1 but also a general purpose information processing terminal while a high security is ensured. The use of a general purpose information processing terminal prevents the delay of the checkout job in peak hours.

The shop clerk using the personal computer 50 wants to carry out a commodity sales processing when moves to the sales area in the second floor, provided by connecting the hardware key 50a removed from the device interface 25 of the device connection unit 20 to the device interface 35 of the device connection unit 30 placed in the second floor. Then, a commodity sales processing in the second floor using the personal computer 50, the barcode scanner 43 and the printer 44 becomes possible according to the inputting of an ID code again by a shop clerk.

Other structures, controls and effects of embodiment 2 are the same as those described in embodiment 1 and are therefore omitted.

### Variation Embodiment 1

The aforementioned embodiments are described on the basis that there is one POS terminal 1 and two device connection units arranged, however, no limitation is given to the number of the POS terminal 1 or the number of the device connection units. Although a USB memory is used as a storage medium, the storage medium is not limited to be this case and can be any storage medium that can store data such as a SD memory card or a NFC (near Field Communication) device.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A device connection unit capable of connecting the peripherals related to a commodity sales processing, comprising:
a control unit configured to carry out a data transmission/reception between an information processing terminal and the device connection unit if the information stored in the information processing terminal is consistent with that stored in a storage medium accessing the device connection unit.

2. The device connection unit according to claim 1, wherein
the control unit carries out a data transmission/reception between the information processing terminal and the device connection unit if the IP address sent from the information processing terminal is the consistent with that stored in the storage medium connected with the device connection unit.

3. The device connection unit according to claim 1, wherein
the control unit carries out a data transmission/reception between the information processing terminal and the device connection unit if the IP address of the information processing terminal is the consistent with that stored in the storage medium connected with the device connection unit and the ID code of the user using the information processing terminal is consistent with that registered in advance.

4. A commodity sales processing system, comprising:
a commodity sales processing apparatus configured to execute a commodity sales processing;
a device connection unit configured to be capable of connecting the peripherals related to a commodity sales processing; and
a storage medium configured to be capable of accessing the device connection unit, wherein
the device connection unit executes a data transmission/reception with an information processing terminal if the information stored in the information processing terminal is consistent with that stored in the storage medium accessing the device connection unit.

5. The commodity sales processing system according to claim 4, wherein
the commodity sales processing apparatus executes a commodity sales processing based on a pre-registered application program; and
the information processing terminal stores an application program the same as that registered in the commodity sales processing apparatus and executes the commodity sales processing according to the stored application program together with the peripherals connected with the device connection unit.

6. A method for an apparatus including a device connection unit capable of connecting the peripherals related to a commodity sale processing, a storage medium capable of accessing the device connection unit and a computer, comprising:
making the computer execute a data transmission/reception between an information processing terminal and the device connection unit if the information stored in the information processing terminal is consistent with that stored in the storage medium accessing the device connection unit.
